(19) United States
(12) Patent Application Publication
(10) Pub. No.: US 2024/0235348 A1
(43) Pub. Date: Jul. 11, 2024

(54) ALIGNMENT SYSTEM FOR STATOR CORE

(71) Applicant: Ford Motor Company, Dearborn, MI (US)

(72) Inventor: Petar Bosankic, Utica, MI (US)

(73) Assignee: Ford Motor Company, Dearborn, MI (US)

(21) Appl. No.: 18/150,419

(22) Filed: Jan. 5, 2023

(51) Int. Cl. H02K 15/16; H02K 1/12

(52) U.S. Cl. CPC H02K 15/16; H02K 1/12

(57) ABSTRACT

An alignment tool for positioning an end plate on a core shaft of a stator core includes a central shaft disposed about a central axis and an outer body. The central shaft has a proximal end and extends in an axial direction therefrom to a free distal end. The outer body includes a base portion, a support portion and a push portion. The base portion is coupled to the proximal end of the central shaft. The support portion is spaced apart from the central shaft and extends from the base portion in the axial direction to the push portion. The push portion is arranged around the central shaft and has a lower surface defining a plane to which the central axis is normal.

### FIELD

The present disclosure relates to electric motors, and assembly thereof, with an end plate and a core shaft.

### BACKGROUND

The statements in this section merely provide background information related to the present disclosure and may not constitute prior art.

Recent advancements in electric converters such as electric motors and/or generators relate not only to performance, but also to manufacturing, as the need for electric converters has increased in various industries. More particularly, in the automotive industry, electric motors can vary across different platforms to account for powertrain requirements of different vehicles.

For example, stators of electric motors are complex assemblies, typically having an end plate that is placed onto a core shaft. During assembly of the stator, misalignment of the end plate with the core shaft may cause the end plate to become stuck onto the core shaft. Correcting the stuck end plate may require additional time that impedes production of the motor.

These and other issues related to the assembly of a stator for an electric motor are addressed by the present disclosure.

### SUMMARY

This section provides a general summary of the disclosure and is not a comprehensive disclosure of its full scope or all of its features.

In one form, an alignment system for a stator core includes a hollow core shaft, an end plate, and an alignment tool. The hollow core shaft defines a central axis of the stator core. The end plate defines a central opening configured to receive the hollow core shaft. The alignment tool includes a central shaft and an outer body. The central shaft has an outer diameter smaller than an inner diameter of the hollow core shaft such that a distal end of the central shaft is configured to be received in the hollow core shaft and slide axially therein. The outer body includes a base portion, a support portion, and a push portion, the base portion being coupled to a proximal end of the central shaft, the support portion being spaced apart from the central shaft and connecting the base portion to the push portion, the push portion being disposed about the central shaft and having a lower surface configured to contact the end plate when the hollow core shaft is received in the central opening of the end plate and the central shaft is disposed within the hollow core shaft. When the central shaft of the alignment tool is disposed in the hollow core shaft of the stator core, the lower surface of the push portion defines a plane to which the central axis of the stator core is normal. The lower surface is configured to align the end plate with the plane such that axially sliding the central shaft into the hollow core shaft pushes the end plate axially along the hollow core shaft.

In variations of the system, which may be implemented individually or in combination: the alignment tool further includes a leg extending radially outward from the push portion, the leg configured to contact the end plate; the alignment tool further includes a fastener joining the proximal end of the central shaft to the base portion; a diameter of the central opening of the end plate is within 0.040 millimeters of an outer diameter of the hollow core shaft; the support portion defines an opening extending axially along the support portion and radially through the support portion; the hollow core shaft includes a distal surface, and the lower surface of the alignment tool is configured to move the end plate along the hollow core shaft onto the distal surface while the central shaft slides axially into the hollow core shaft; the end plate includes an inner wall that defines the central opening, and the lower surface is configured to align the inner wall parallel to the central axis of the stator core when the central shaft is disposed within the hollow core shaft; the lower surface is an annular shape concentric with the central shaft the lower surface having an inner diameter that is greater than an outer diameter of the hollow core shaft and less than an outer diameter of the end plate.

A method for installing an end plate of a stator core on a hollow core shaft of the stator core includes placing the end plate on the hollow core shaft such that the hollow core shaft extends through a central opening of the end plate, inserting a central shaft of an alignment tool into an interior of the hollow core shaft, sliding the central shaft axially into the hollow core shaft until a lower surface of the alignment tool contacts an upper surface of the end plate, and sliding the central shaft axially further into the hollow core shaft until the lower surface pushes the end plate onto a distal end portion of the hollow core shaft. The contact between the lower surface of the alignment tool and the upper surface of the end plate maintains a central axis of the central opening of the end plate to be coaxial with a central axis of the hollow core shaft.

In variations of the method, which may be implemented individually or in combination: the hollow core shaft is positioned such that the central axis of the hollow core shaft is vertical while sliding the central shaft axially until the lower surface pushes the end plate onto the distal end portion of the hollow core shaft; the distal end portion of the hollow core shaft defines a plane to which the central axis of the hollow core shaft is normal; the lower surface is an annular shape concentric with the central shaft and the alignment tool includes a leg extending radially outward from the lower surface, and the leg contacts the end plate while sliding the central shaft axially until the lower surface pushes the end plate onto the distal end portion of the hollow core shaft; a diameter of the central opening of the end plate is greater than an outer diameter of the hollow core shaft by no more than 0.040 millimeters; the end plate includes an inner wall that defines the central opening, placing the end plate on the hollow core shaft positions the central axis of the central opening of the end plate to be at an angle relative to the central axis of the hollow core shaft such the inner wall engages an outer surface of the hollow core shaft to inhibit the end plate from moving axially along the hollow core shaft toward the distal end portion; contact between the lower surface and the upper surface of the end plate dislodges the inner wall from the outer surface of the hollow core shaft to permit the end plate to move axially along the hollow core shaft toward the distal end portion.

An alignment tool for positioning an end plate on a core shaft of a stator core includes a central shaft and an outer body. The central shaft is disposed about a central axis, the central shaft having a proximal end and extending in an axial direction therefrom to a free distal end. The outer body includes a base portion, a support portion and a push portion, the base portion being coupled to the proximal end of the central shaft, the support portion being spaced apart from the central shaft and extending from the base portion in the axial direction to the push portion, the push portion arranged around the central shaft and having a lower surface defining a plane to which the central axis is normal.

In variations of the tool, which may be implemented individually or in combination: the support portion is a cylindrical shape disposed about the central axis and defines an annular space between the support portion and the central shaft, the support portion defining a plurality of openings extending radially through the support portion; the proximal end of the central shaft includes an upper plate, and the tool further includes a fastener joining the upper plate of the central shaft to the base portion of the outer body; the central shaft defines a plurality of openings extending axially along the central shaft; the lower surface is an annular surface disposed concentrically about the central shaft.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a perspective view of an alignment system for a stator core according to the teachings of this disclosure;

FIG. 2 is a perspective view of a hollow core shaft of the alignment system of FIG. 1;

FIG. 3 is a perspective view of an end plate of the alignment system of FIG. 1;

FIG. 4 is a perspective view of an alignment tool of the alignment system of FIG. 1;

FIG. 5 is a perspective view of a central shaft of the alignment tool of FIG. 4;

FIG. 6 is a perspective view of an outer body of the alignment tool of FIG. 4;

FIG. 7 is a perspective view of another alignment tool according to the present disclosure;

FIG. 8 is a side cross-sectional view of the end plate lodged on the hollow core shaft according to the present disclosure;

FIG. 9 is a side cross-sectional view of the alignment tool of FIG. 4 dislodging the end plate according to the present disclosure;

FIG. 10 is a side cross-sectional view of the alignment tool of FIG. 4 placing the end plate at a distal end of the hollow core shaft according to the present disclosure; and

FIG. 11 is a side cross-sectional view of the alignment tool of FIG. 4 being removed from the hollow core shaft according to the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

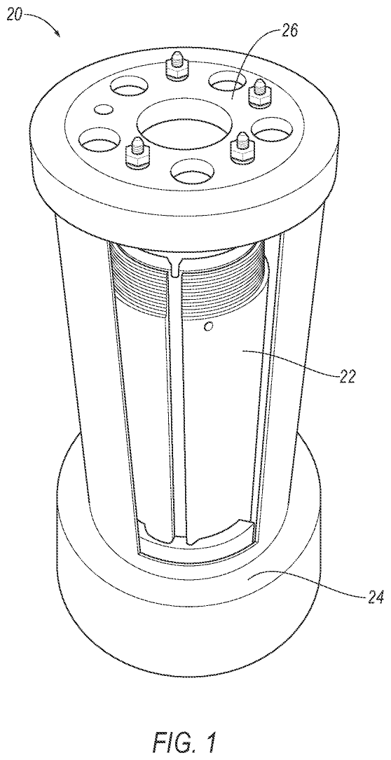

With reference to FIG. 1, an alignment system 20 for a stator core includes a hollow core shaft 22, an end plate 24, and an alignment tool 26. During manufacture of the stator core, the end plate 24 may become misaligned and become stuck on the hollow core shaft 22, inhibiting movement of the end plate 24 to its intended position at the end of the stator core. The alignment tool 26 realigns the end plate 24 with the hollow core shaft 22 and pushes the end plate 24 to the end of the hollow core shaft 22. The alignment tool 26 thus provides a faster way to realign the end plate 24 on the hollow core shaft 22 than manually pressing or removing the end plate 24. As such, manufacturing of electric motors is improved.

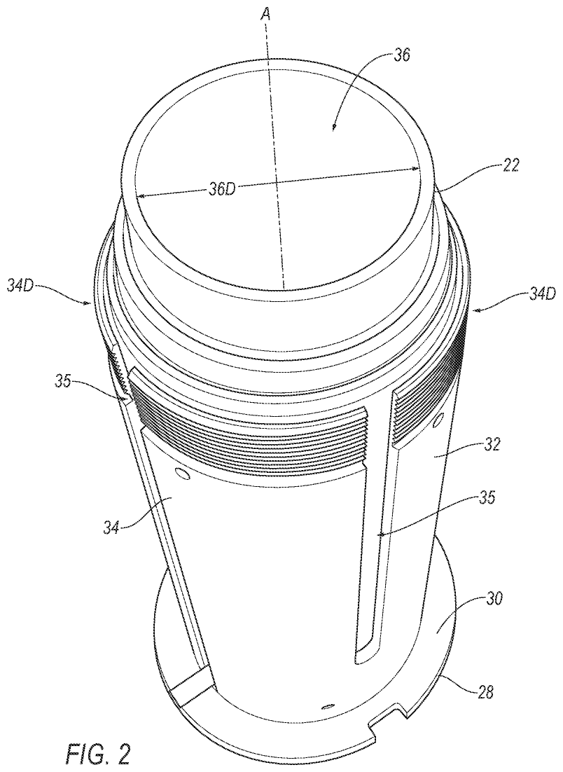

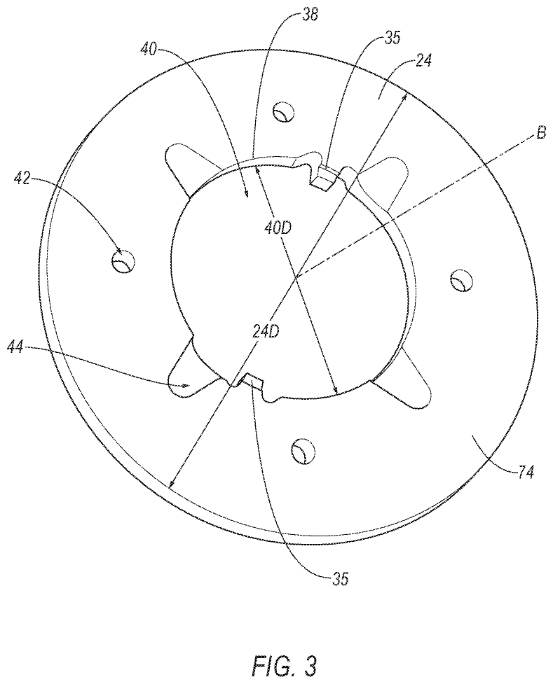

Now referring to FIG. 2, the hollow core shaft 22 is shown. The hollow core shaft 22 defines a central axis A of the stator core, and the other components of the stator core are aligned to the central axis A. The hollow core shaft 22 includes a distal end portion 28 defining a distal surface 30 and a shaft portion 32 extending upward from the distal surface 30. The shaft portion 32 has an outer surface 34 defining an outer diameter 34D and defines an interior bore 36 with an inner diameter 36D. In the form of FIG. 2, the outer surface 34 includes one or more openings or slots, also referred to as keyways 35, that protrude radially inward at least partially into the shaft portion 32 and extend axially along the shaft portion 32. As such, it is understood that the outer diameter 34D is a maximum distance between radially opposing (i.e., diametrically opposite) points on the outer surface 34, i.e., a largest diameter of the outer surface 34. The outer surface 34 is substantially smooth to allow the end plate 24 (FIG. 3) to slide along without catching, lodging, or stopping thereon. The end plate 24 (FIG. 3) is placed about the shaft portion 32 so that it rests on the distal surface 30 to form one end of the stator core, and laminates (not shown) are then stacked onto the end plate 24 along the hollow core shaft 22. The hollow core shaft 22 thus aligns the laminates and the end plate 24 along the central axis A, which is configured to be coaxial with the rotational axis of the motor.

With reference to FIG. 3, the end plate 24 is shown. The end plate 24 includes an inner wall 38 that defines a central opening 40 configured to receive the hollow core shaft 22, and the central opening 40 defines a central axis B. The central opening 40 defines a diameter 40D that is larger than the outer diameter 34D of the shaft portion 32 to allow the end plate 24 to move along the outer surface 34 of the hollow core shaft 22. In one form, the diameter 40D of the central opening 40 is within 0.040 millimeters (mm) of the outer diameter 34D of the shaft portion 32, to within machine tolerances.

When the central axis B of the end plate 24 aligns with the central axis A of the hollow core shaft 22, the end plate 24 can move along the hollow core shaft 22 unimpeded. However, during assembly of the stator core, the central axis B of the end plate 24 may become misaligned, i.e., may rotate to an angle relative to the central axis A of the hollow core shaft 22, and the inner wall 38 may engage the outer surface 34 of the hollow core shaft 22, lodging the end plate 24 partially along the shaft portion 32. When the inner wall 38 engages the hollow core shaft 22, the end plate 24 is inhibited from moving axially along the shaft portion 32 toward the distal end portion 28.

In the form of FIG. 3, the end plate may include one or more additional openings 42 and/or vent slots 44 that are used in construction of the stator core, such as venting air during resin application. The end plate 24 may optionally include one or more keys 45 that protrude radially inward from the inner wall 38 and are configured to be received in a corresponding keyway 35 to maintain a rotational alignment of the end plate 24 on the shaft portion 32.

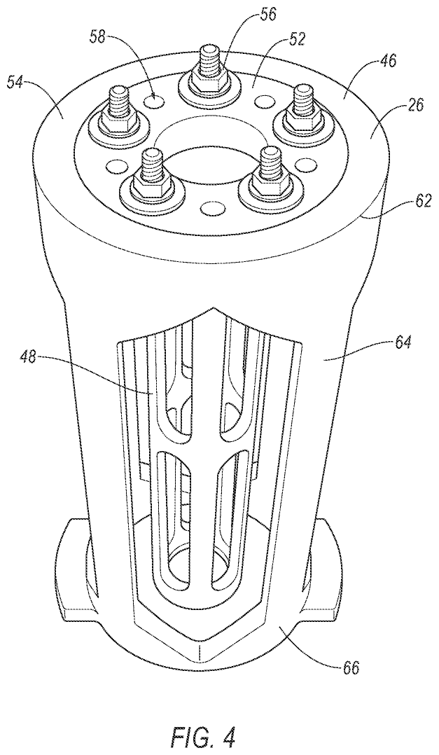

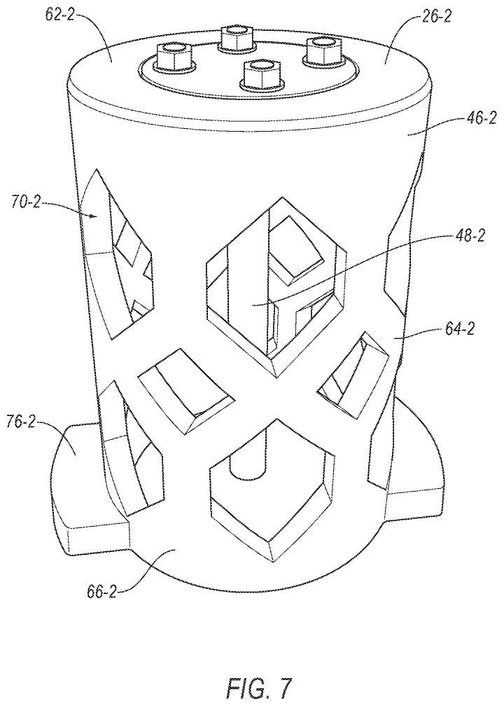

With additional reference to FIGS. 4-6, the alignment tool 26 is configured to align the end plate 24 with the hollow core shaft 22. The alignment tool 26 includes an outer body 46 and a central shaft 48. The outer body 46 extends around the hollow core shaft 22 to push the end plate 24, and the central shaft 48 moves axially along the interior bore 36 of the hollow core shaft 22, thereby aligning the central axis B of the end plate 24 with the central axis A of the hollow core shaft 22. Thus, the outer body 46 and the central shaft 48 realign the misaligned end plate 24 to the central axis A and move the end plate 24 onto the distal surface 30 of the distal end portion 28 of the hollow core shaft 22. One form of the alignment tool 26 is shown in FIG. 4, and another form of the alignment tool 26-2 is shown in FIG. 7, described in more detail below.

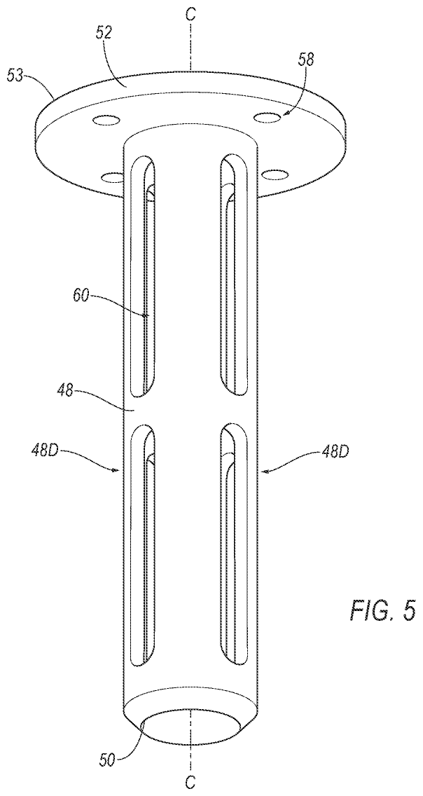

More specifically shown in FIG. 5, the central shaft 48 is configured to align the alignment tool 26 to the hollow core shaft 22. The central shaft 48 is configured to be received in the interior bore 36 of the shaft portion 32 of the hollow core shaft 22 and to slide axially therein. More specifically, the central shaft 48 has an outer diameter 48D that is smaller than the inner diameter 36D of the shaft portion 32, and a distal end 50 of the central shaft 48 is inserted into the interior bore 36 of the hollow core shaft 22. Upon insertion, the central shaft 48 slides along the hollow core shaft 22, aligning the alignment tool 26 with the central axis A of the hollow core shaft 22. The central shaft 48 includes an upper plate 52 at a proximal end 53 that is coupled to a proximal end 54 of the outer body 46 with one or more fasteners 56 (FIG. 4), such as bolts or pins, extending through at least one opening 58 defined in the upper plate 52. In an alternative form, the proximal end 53 may be coupled to the proximal end 54 in another manner, such as adhesive, welding, soldering, brazing, or other types of fasteners, for example. In yet another form, the proximal end 53 may be integrally formed with the proximal end 54, such as with the entire alignment tool 26 being integrally formed as a single piece of material (e.g., machined, cast, molded, 3D printed). In the form of FIGS. 4-6, the central shaft may optionally define one or more axially extending openings 60 or slots to reduce an overall weight of the alignment tool 26. These openings 60 may also reduce surface friction between the central shaft 48 and the hollow core shaft 22. In another form shown in FIG. 7, the central shaft 48-2 of the alignment tool 26-2 is solid.

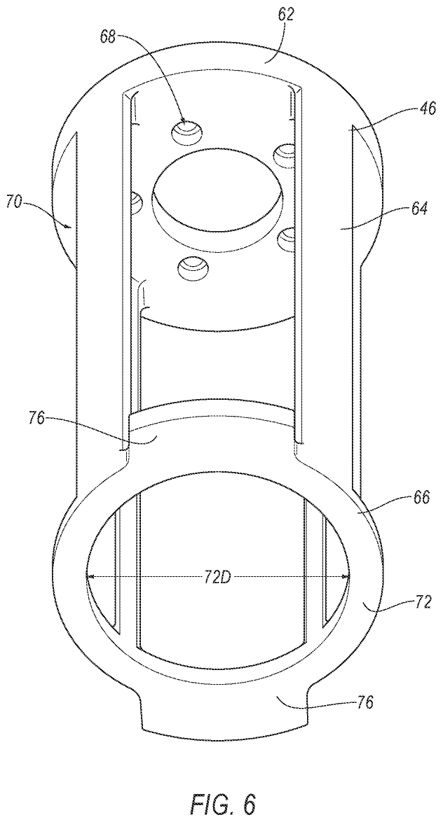

As shown in further detail in FIG. 6, the outer body 46 includes a base portion 62, a support portion 64, and a push portion 66. The base portion 62 generally supports the other components of the alignment tool 26. In one form, the base portion 62 is coupled to the proximal end 53 of the central shaft 48, such as the upper plate 52 described above, with suitable fasteners 56 such as bolts. In the example provided, the base portion 62 defines openings 68 to receive the fasteners 56. Coupling the proximal end 53 of the central shaft 48 to the base portion 62 forms a unitary upper portion of the alignment tool 26 that extends above the hollow core shaft 22 during placement of the end plate 24 onto the hollow core shaft 22. That is, generally, the base portion 62 is disposed above the hollow core shaft 22 in order to allow the push portion 66 to reach the distal surface 30 of the hollow core shaft 22. In one form, the outer body 46 is formed of a metal. In another form, the outer body 46 may be formed of any suitable material, such as a plastic or a composite, to decrease the overall weight of the alignment tool 26. In one form, the outer body 46 may be additively manufactured. In other forms, the outer body 46 may be cast, molded, machined, or manufactured by any other suitable method.

The support portion 64 connects the base portion 62 to the push portion 66. In general, the support portion 64 defines a cylindrical internal shape defining an annular space with the central shaft 48. The support portion 64 is spaced radially from the central shaft 48 so as not to inhibit movement of the alignment tool 26 along the hollow core shaft 22. The support portion 64 is sized such that an axial length of the support portion 64 is greater than an axial length of the hollow core shaft 22. That is, for the push portion 66 to reach the distal end portion 28 of the hollow core shaft 22, the support portion 64 spaces the push portion 66 from the base portion 62 to a distance greater than the axial length of the hollow core shaft 22. The support portion 64 may further be sized such that the axial length of the support portion is less than an axial length of the central shaft 48. That is, the central shaft 48 may extend from the base portion 62 (which is axially above the support portion 64) to the push portion 66 (which is axially below the support portion 64). When the central shaft 48 is longer than the support portion 64, that the central shaft 48 enters the hollow core shaft 22 to align the outer body 46 when the push portion 66 is placed over the hollow core shaft 22. Thus, the outer body 46 is aligned to the hollow core shaft 22 to dislodge the end plate 24 before the support portion 64 is moved onto the hollow core shaft 22.

In the form shown, the support portion 64 is a set of axial posts arranged circumferentially around the central shaft 48 with one end of each axial post coupled to the base 62 portion and the opposite end of each post coupled to the push portion 66. The axial posts define openings 70 extending axially along the support portion 64 and radially through the support portion 64. The openings 70 decrease the overall weight of the alignment tool 26. In this form, the openings 70 are substantially rectangular. In another form, shown in FIG. 7, the support portion 64-2 extending from the base portion 62-2 is substantially cylindrical and defines one or more polygonal openings 70-2 to decrease the weight of the alignment tool 26-2, though any suitable shape may be used, including curved or irregular shapes. In this form, the openings 70-2 may be formed during additive manufacturing of the outer body 46-2. In another form, the support portion 64 may be devoid of radial openings (e.g., openings 70 or 70-2).

The push portion 66 pushes the end plate 24 to the distal end portion 28 of the hollow core shaft 22, aligning the central axes A, B of the hollow core shaft 22 and the end plate 24. More specifically, the central shaft 48 being disposed within the shaft portion 32 positions the push portion 66 to be disposed about the central shaft 48 such that a lower surface 72 contacts an upper surface 74 of the end plate 24. The lower surface 72 has an annular shape concentric with the central shaft 22. That is, the lower surface 72 is an annular surface that defines an inner diameter 72D that is greater than the outer diameter 34D of the shaft portion 32 of the hollow core shaft 22 and less than an outer diameter 24D of the end plate 24. The inner diameter 72D of the lower surface 72 is thus sized such that the push portion 66 contacts the end plate 24 but does not contact the hollow core shaft 22 when the central shaft 48 is received in the shaft portion 32.

The lower surface 72 is configured to move the end plate 24 along the outer surface 34 of the shaft portion 32 and onto the distal surface 30 while the central shaft 48 slides axially into the interior bore 36 of the shaft portion 32. That is, the lower surface 72 of the push portion 66 presses the upper surface 74 of the end plate 24 substantially evenly in the axial direction, generating substantially evenly distributed pressure in the axial direction. The even distribution of the pressure by the push portion 66 aligns the inner wall 38 of the end plate 24 to be parallel to the central axis A of the hollow core shaft 22. More specifically, the lower surface 72 of the push portion 66 defines a plane (described in further detail below) to which a central axis C (FIG. 5) of the central shaft 48 and, thus the central axis A of the hollow core shaft 22, is normal. The central axis C of the central shaft 48 defines a central axis of the alignment tool 26 as a whole, referred to herein as “the central axis C”. The end plate 24 is properly aligned when the end plate 24 is aligned with this plane at the distal end portion 28 of the hollow core shaft 22. Thus, when the end plate 24 is misaligned and stuck on the hollow core shaft 22, the contact between the lower surface 72 of the push portion 66 and the upper surface of the end plate 24 dislodges the inner wall 38 from the outer surface 34 of the hollow core shaft 22. Dislodging the inner wall 38 permits the end plate 24 to move axially along the hollow core shaft 22 toward the distal end portion 28.

In one form, the alignment tool 26 may further include one or more legs 76 extending radially outward from the push portion 66. The legs 76 are part of the lower surface 72 of the push portion 66 and are configured to contact the end plate 24. That is, the legs 76 contact the upper surface 74 of the end plate 24 and press the upper surface 74 evenly in the axial direction, contributing to the dislodging of the inner wall 38 from the outer surface 34 of the shaft portion 32. Then, the legs 76 push the end plate 24 onto the distal surface 30 of the hollow core shaft 22. The legs 76 are aligned with the plane of the lower surface 72, thereby aligning the end plate 24 upon contact. In the form of FIG. 7, the push portion 66-2 includes legs 76-2, and it is within the scope of the disclosure that the alignment tool 26, 26-2 lacks legs 76, 76-2.

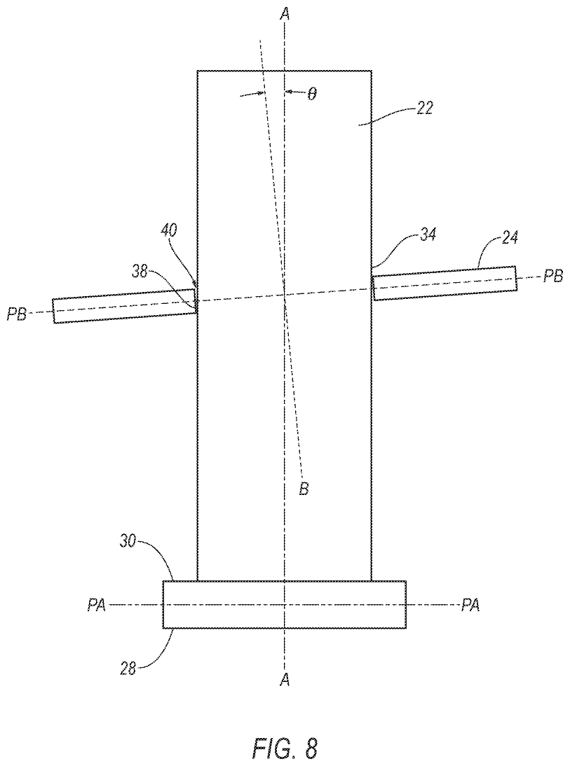

Now referring to FIG. 8, a process for dislodging the end plate 24 from the hollow core shaft 22 is shown. In the example provided, the process takes place with the hollow core shaft 22 in a substantially vertical position such that gravity acts in a direction substantially parallel to the axis A and downward toward the distal surface 30 as illustrated in FIG. 8, though other orientations of the hollow core shaft 22 relative to gravity can be used. The process begins by placing the end plate 24 on the hollow core shaft 22 such that the hollow core shaft 22 extends through the central opening 40 of the end plate 24. During this placement, the end plate 24 may become misaligned such that the inner wall 38 is lodged against the outer surface 34 of the hollow core shaft 22. That is, the end plate 24 defines a plane PB and a central axis B normal to the plane PB that are misaligned relative to a plane PA of the hollow core shaft 22 and a central axis A of the hollow core shaft 22 normal to the plane PA. Specifically, the central axis B of the end plate 24 defines a nonzero angle θ with the central axis A of the hollow core shaft 22. That is, the central axis A is vertically positioned, and the end plate 24 is angled relative to the vertical central axis A, lodging the end plate 24 against the outer surface 34 of the hollow core shaft 22.

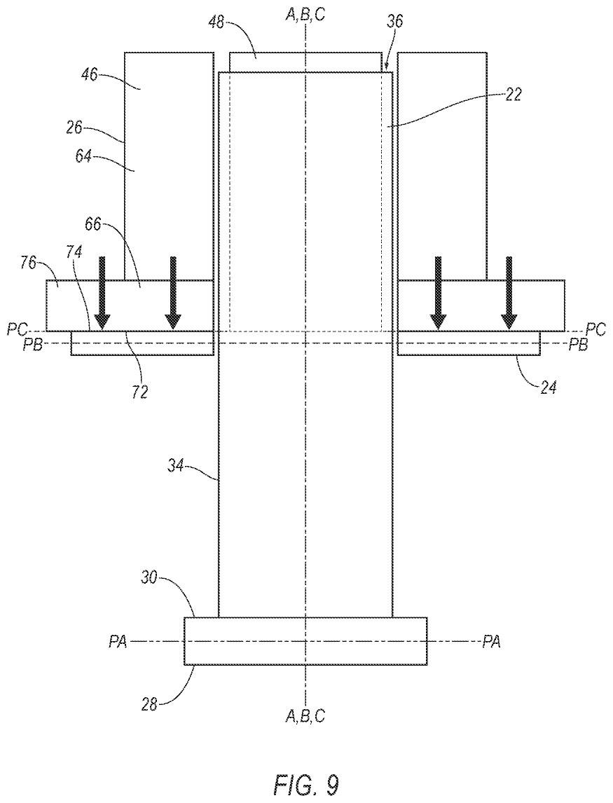

Next, as shown in FIG. 9, the alignment tool 26 is placed onto the end plate 24. Specifically, the central shaft 48 of the alignment tool is inserted into the interior bore 36 of the hollow core shaft 22, and the central shaft 48 is slid in a first axial direction into the hollow core shaft 22 until the lower surface 72 of the alignment tool 26 contacts the upper surface 74 of the end plate 24. That is, pressing the base portion 62 and/or the support portion 64 vertically downward causes the lower surface 72 of the push portion 66 and/or the legs 76 to provide even axial pressure to the end plate 24 along a plane PC that is parallel to the plane PA of the hollow core shaft 22. The even axial pressure of the push portion 66 dislodges the end plate 24 from the hollow core shaft 22 and realigns the central axis B of the end plate 24 to be coaxial with the central axis A of the hollow core shaft 22 and the central axis C of the alignment tool 26. The plane PB of the end plate 24 thus is realigned to be parallel to the plane PA of the hollow core shaft 22. In another form, the end plate 24 is placed on the alignment tool 26 prior to placing the alignment tool 26 onto the hollow core shaft 22, such that the end plate 24 does not become lodged against the hollow core shaft 22. In such a form, the step shown in FIG. 8 is omitted.

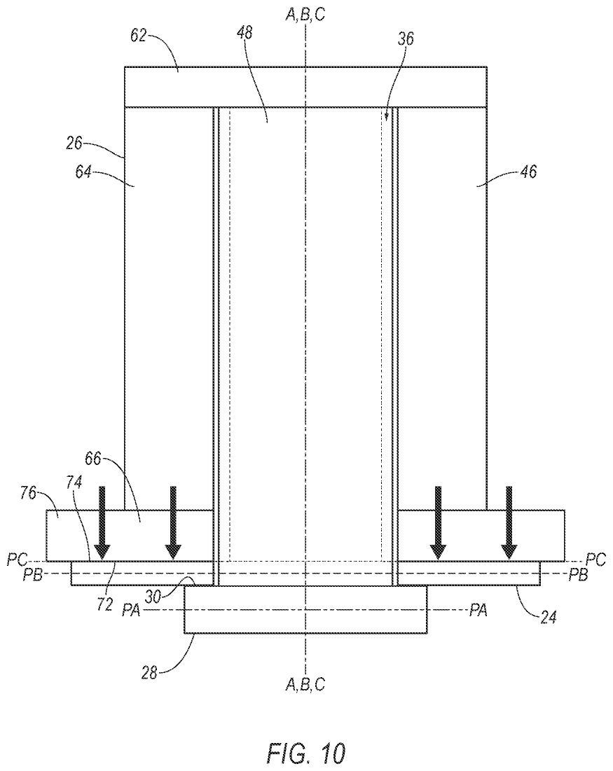

Next, as shown in FIG. 10, the alignment tool 26 moves the end plate 24 onto the distal end portion 28 of the hollow core shaft 22. By sliding the central shaft 48 axially into the hollow core shaft 22, the lower surface 72 pushes the end plate 24 until the distal end portion 28 stops further movement. When the end plate 24 is disposed on the distal surface 30 at the distal end portion 28, the central axes A, B, C of the hollow core shaft 22, the end plate 24, and the alignment tool 26 are aligned, and the planes PA, PB, PC of the hollow core shaft 22, the end plate 24, and the alignment tool 26 are parallel. That is, the end plate 24 is properly aligned to the hollow core shaft 22.

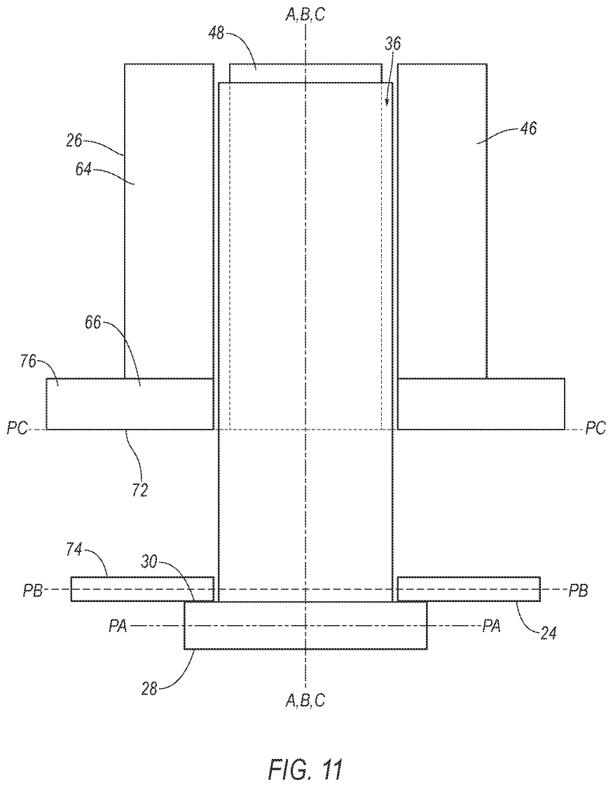

Next, as shown in FIG. 11, the alignment tool 26 is removed from the hollow core shaft 22. Lifting the base portion 62 or the support portion 64 of the outer body 46 vertically in a second axial direction along the central axis A slides the central shaft 48 axially out of the interior bore 36 of the hollow core shaft 22. The lower surface 72 of the push portion 66 is moved away from the upper surface 74 of the end plate 24, leaving the end plate 24 aligned to the hollow core shaft 22. Upon removal of the alignment tool 26, the process can repeat with another hollow core shaft 22 and another end plate 24.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

Ordinal terms such as “first,” “second,” “third,” etc., are used herein as descriptors and do not imply order or importance.

The description of the disclosure is merely exemplary in nature and, thus, variations that do not depart from the substance of the disclosure are intended to be within the scope of the disclosure. Such variations are not to be regarded as a departure from the spirit and scope of the disclosure.

1. An alignment system for a stator core, the alignment system comprising:
a hollow core shaft defining a central axis of the stator core;
an end plate defining a central opening configured to receive the hollow core shaft; and
an alignment tool comprising:
a central shaft having an outer diameter smaller than an inner diameter of the hollow core shaft such that a distal end of the central shaft is configured to be received in the hollow core shaft and slide axially therein; and
an outer body including a base portion, a support portion, and a push portion, the base portion being coupled to a proximal end of the central shaft, the support portion being spaced apart from the central shaft and connecting the base portion to the push portion, the push portion being disposed about the central shaft and having a lower surface configured to contact the end plate when the hollow core shaft is received in the central opening of the end plate and the central shaft is disposed within the hollow core shaft;
wherein when the central shaft of the alignment tool is disposed in the hollow core shaft of the stator core, the lower surface of the push portion defines a plane to which the central axis of the stator core is normal, and
wherein the lower surface is configured to align the end plate with the plane such that axially sliding the central shaft into the hollow core shaft pushes the end plate axially along the hollow core shaft.

2. The system of claim 1, wherein the alignment tool further comprises a leg extending radially outward from the push portion, the leg configured to contact the end plate.

3. The system of claim 1, wherein the alignment tool further comprises a fastener joining the proximal end of the central shaft to the base portion.

4. The system of claim 1, wherein a diameter of the central opening of the end plate is within 0.040 millimeters of an outer diameter of the hollow core shaft.

5. The system of claim 1, wherein the support portion defines an opening extending axially along the support portion and radially through the support portion.

6. The system of claim 1, wherein the hollow core shaft includes a distal surface, and the lower surface of the alignment tool is configured to move the end plate along the hollow core shaft onto the distal surface while the central shaft slides axially into the hollow core shaft.

7. The system of claim 1, wherein the end plate includes an inner wall that defines the central opening, and the lower surface is configured to align the inner wall parallel to the central axis of the stator core when the central shaft is disposed within the hollow core shaft.

8. The system of claim 1, wherein the lower surface is an annular shape concentric with the central shaft the lower surface having an inner diameter that is greater than an outer diameter of the hollow core shaft and less than an outer diameter of the end plate.

9. A method for installing an end plate of a stator core on a hollow core shaft of the stator core, the method comprising:
placing the end plate on the hollow core shaft such that the hollow core shaft extends through a central opening of the end plate;
inserting a central shaft of an alignment tool into an interior of the hollow core shaft;
sliding the central shaft axially into the hollow core shaft until a lower surface of the alignment tool contacts an upper surface of the end plate; and
sliding the central shaft axially further into the hollow core shaft until the lower surface pushes the end plate onto a distal end portion of the hollow core shaft,
wherein the contact between the lower surface of the alignment tool and the upper surface of the end plate maintains a central axis of the central opening of the end plate to be coaxial with a central axis of the hollow core shaft.

10. The method of claim 9, wherein the hollow core shaft is positioned such that the central axis of the hollow core shaft is vertical while sliding the central shaft axially until the lower surface pushes the end plate onto the distal end portion of the hollow core shaft.

11. The method of claim 10, wherein the distal end portion of the hollow core shaft defines a plane to which the central axis of the hollow core shaft is normal.

12. The method of claim 9, wherein the lower surface is an annular shape concentric with the central shaft and the alignment tool includes a leg extending radially outward from the lower surface, and wherein the leg contacts the end plate while sliding the central shaft axially until the lower surface pushes the end plate onto the distal end portion of the hollow core shaft.

13. The method of claim 9, wherein a diameter of the central opening of the end plate is greater than an outer diameter of the hollow core shaft by no more than 0.040 millimeters.

14. The method of claim 9, wherein the end plate includes an inner wall that defines the central opening, wherein placing the end plate on the hollow core shaft positions the central axis of the central opening of the end plate to be at an angle relative to the central axis of the hollow core shaft such the inner wall engages an outer surface of the hollow core shaft to inhibit the end plate from moving axially along the hollow core shaft toward the distal end portion.

15. The method of claim 14, wherein contact between the lower surface and the upper surface of the end plate dislodges the inner wall from the outer surface of the hollow core shaft to permit the end plate to move axially along the hollow core shaft toward the distal end portion.

16. An alignment tool for positioning an end plate on a core shaft of a stator core, the tool comprising:
a central shaft disposed about a central axis, the central shaft having a proximal end and extending in an axial direction therefrom to a free distal end; and
an outer body including a base portion, a support portion and a push portion, the base portion being coupled to the proximal end of the central shaft, the support portion being spaced apart from the central shaft and extending from the base portion in the axial direction to the push portion, the push portion arranged around the central shaft and having a lower surface defining a plane to which the central axis is normal.

17. The tool of claim 16, wherein the support portion is a cylindrical shape disposed about the central axis and defines an annular space between the support portion and the central shaft, wherein the support portion defines a plurality of openings extending radially through the support portion.

18. The tool of claim 16, wherein the proximal end of the central shaft includes an upper plate, and the tool further comprises a fastener joining the upper plate of the central shaft to the base portion of the outer body.

19. The tool of claim 16, wherein the central shaft defines a plurality of openings extending axially along the central shaft.

20. The tool of claim 16, wherein the lower surface is an annular surface disposed concentrically about the central shaft.
